(19) United States
(12) Patent Application Publication
(10) Pub. No.: US 2017/0178842 A1
(43) Pub. Date: Jun. 22, 2017

(54) SWITCHING DEVICE

(71) Applicant: EATON INDUSTRIES (AUSTRIA) GMBH, Schrems (AT)

(72) Inventors: Adolf TETIK, Vienna (AT); Nikola BOJANIC, Vienna (AT)

(21) Appl. No.: 15/312,188

(22) PCT Filed: May 19, 2015
(86) PCT No.: PCT/EP2015/060987

§ 371 Date: Feb. 16, 2017

(30) Foreign Application Priority Data
May 22, 2014 (DE) 10 2014 107 266.9

(51) Int. Cl. H01H 21/22; H01H 21/40

(52) U.S. Cl. CPC H01H 21/22; H01H 21/40; H01H 2205/002

(57) ABSTRACT

A switching device has: a contact secured to a housing; a movable contact arranged on a contact arm arranged to be movable inside the switching device and including an extension facing away from the movable contact, the movable contact being designed to enter in contact with the contact that is secured to the housing; a breaker mechanism connected to the movable contact arm; a manually operated lever which is connected to the breaker mechanism; and a snap-action closing mechanism including a rotatably mounted snap action rocker which is controlled by a first cam of the manually operated lever and which includes a contact arm-catching unit that is to come in contact with the extension of the contact arm. The contact arm-catching unit preferably has a surface hardness which is greater than or equal to the surface hardness of the extension of the contact arm.

### CROSS-REFERENCE TO RELATED APPLICATIONS

This application is a U.S. national stage application under 35 U.S.C. §371 of International Application No. PCT/EP2015/060987, filed on May 19, 2015, and claims benefit to German Patent Application No. DE 10 2014 107 266.9, filed on May 22, 2014. The International Application was published in German on Nov. 26, 2015, as WO 2015/177143 A1under PCT Article 21(2).

### FIELD

The invention relates to a switching device having a fixed contact and a movable contact.

### BACKGROUND

In low-voltage switching devices which have a manually operated control button, therefore a manually operable element for closing the switch contacts and establishing a conductive current path through the switching device, usually a movable switch contact, which is mechanically coupled to the manually operated control button, is continuously brought closer to a switch contact that is secured to the housing by moving the manually operated control button until the two switch contacts abut one another. In the process, an arc is formed if there is an electrical potential on the switching device in question and upon a certain approach of the two switch contacts.

In the event of a sufficiently low voltage and provided that only consumers are connected that only lead to a low current flow via the switching device, this arc does not constitute a problem for the switching device, and the switch contacts, respectively, as a result of its short duration in terms of time. In the event of higher voltages and higher currents, such an arc can, however, already lead to considerable damage to the switching device in question. In the case of protective switching devices in particular, downstream consumers are often switched on when the switch contacts of the protective switching device in question are closed such that an often considerable current immediately flows via the switching device in question. In the process, a slow, manual closing of the switch contacts can not only lead to a total loss of the switching device in question still during the closing process, but also start a fire.

Switching devices, which have a snap-action closing function, are known. In such devices, the switch contacts are closed with a snap action irrespective of the manner and speed with which an operator actuates a manually operated control button.

It has become apparent in practice that especially in the field of compact switching devices, which are conventional in low-voltage applications, the corresponding snap-action closing devices often fail after a relatively low number of closing operations. Such switching devices are normally in use for long periods of time; 20 to 30 years are not uncommon. The snap-action closing devices used in such compact low-voltage switching devices are usually designed such that the switching device in question is still functional even if said closing device fails, just without the snap-action closing function. In the case of such a failure, the switch contacts therefore approach each other slowly the next time they are closed, which can lead directly to a fire. Since the closing is probably manual, the operator in question would also be injured in the process.

### SUMMARY

An aspect of the invention provides a switching device, comprising: a fixed contact secured to a housing and a movable contact, the movable contact being arranged on a contact arm which is configured to be movable inside the switching device, the contact arm including an extension of the contact arm facing away from the movable contact, the movable contact being configured to contact the fixed contact and to establish a conductive current path through the switching device; a breaker mechanism connected to the movable contact arm; a manually operated lever connected to the breaker mechanism; and a snap-action closing mechanism including a snap-action rocker mounted so as to be rotatably movable, controlled by a first cam of the manually operated lever, the snap-action rocker including a contact arm-catching unit configured to contact the extension of the contact arm, wherein the contact arm-catching unit has a surface hardness which is greater than or equal to a surface hardness of the extension of the contact arm.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a front view of a preferred embodiment of a switching device according to the invention without an upper housing shell, in the switched-off state;

FIG. 2 is a front view of the switching device according to FIG. 1 in the switched-on state without a positioning spring;

FIG. 3 is an axonometric view of the arrangement of the switching device according to FIG. 1 comprising a breaker mechanism, contact arm, snap-action closing mechanism and manually operated lever;

FIG. 4 is a front view of the arrangement according to FIG. 3 in the switched-off state;

FIG. 5 is the view according to FIG. 3 without the positioning spring;

FIG. 6 shows the arrangement according to FIG. 5 having a partially opened snap-action rocker, in a state shortly before closing of the contacts, without the positioning spring;

FIG. 7 shows the arrangement according to FIG. 5 with closed contacts;

FIG. 8 is an axonometric view of the snap-action rocker of a switching device according to the invention;

FIG. 9 is a plan view of the partially opened snap-action rocker according to FIG. 8; and

FIG. 10 is an axonometric view of the contact arm, which is constructed as a switching bridge, of a switching device according to the invention.

### DETAILED DESCRIPTION

An aspect of the invention provides a switching device of the type mentioned at the outset, by means of which the aforementioned drawbacks can be avoided, which has a long useful life and allows safe operation over a long time, and in which the snap-action closing function can be ensured over a high number of closing operations.

As a result of this, the functionality of the snap-action closing function can be reliably ensured for a long time and over a large number of closing operations. As a result of this, it can be ensured that a snap-action closing of the switch contacts occurs when the switch contacts are closed, therefore when the switching device is switched on. As a result of this, the snap-action closing function can take place over many closing operations without significant changes. Because the contact arm-catching unit does not have a lower hardness and surface hardness than the extension of the contact arm, signs of wear, in particular material abrasion, on the snap-action rocker can be prevented or reduced such that there is no effect on the snap-action closing function. As a result of this, the stopping point of the snap-action closing device can be prevented from being constantly displaced as a result of material abrasion, until the snap-action rocker can no longer hold the extension of the contact arm and the snap-action closing device becomes ineffective.

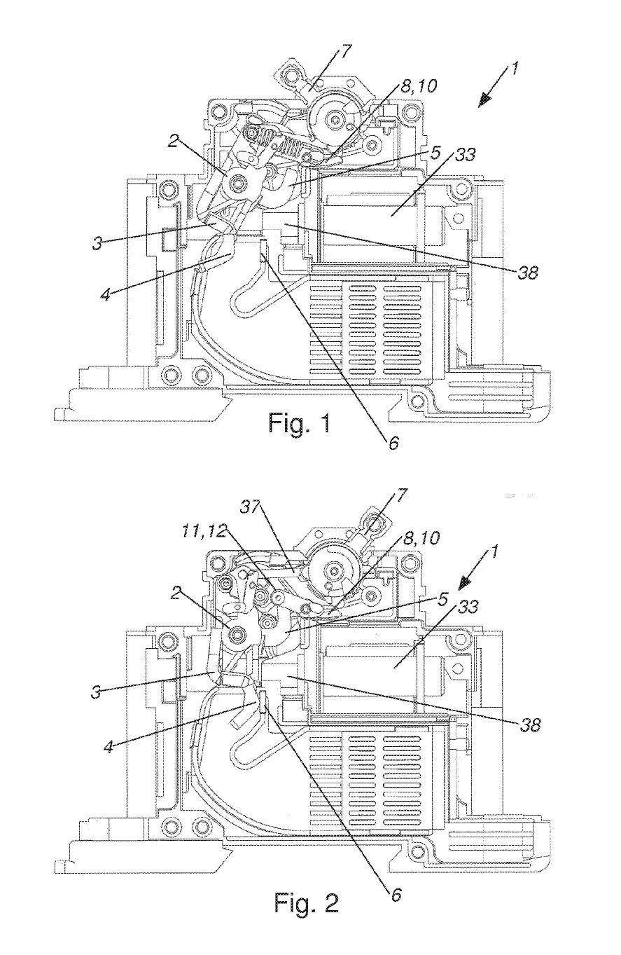

FIG. 1 and FIG. 2 each show a preferred embodiment of a switching device 1 having a contact 6 that is secured to the housing and a movable contact 4, the movable contact 4 being arranged on a contact arm 3 which is arranged so as to be movable inside the switching device 1, which contact arm 3 has an extension 5 of the contact arm facing away from the movable contact 4, the movable contact 4 being provided for coming into contact with the contact 6 that is secured to the housing and for establishing a conductive current path through the switching device 1, the switching device 1 having a breaker mechanism 2, which is connected to the movable contact arm 3, the switching device 1 further having a manually operated lever 7, which manually operated lever 7 is connected to the breaker mechanism 2, the switching device further having a snap-action mechanism 8, which snap-action mechanism 8 has a rotatably mounted snap-action rocker 10 which is controlled by a first cam 9 of the manually operated lever 7 and comprises a contact arm-catching unit 11 that is to come into contact with the extension 5 of the contact arm, the contact arm-catching unit 11 having a surface hardness which is greater than or equal to a surface hardness of the extension 5 of the contact arm.

As a result of this, the functionality of the snap-action closing function can be reliably ensured for a long time and over a large number of closing operations. As a result of this, it can be ensured that a snap-action closing of the contacts 4, 6 occurs when the contacts 4, 6 are closed, therefore when the switching device 1 is switched on. As a result of this, the snap-action closing function can take place over many closing operations without significant changes. Because the contact arm-catching 11 unit does not have a lower hardness and surface hardness than the extension 5 of the contact arm, signs of wear, in particular material abrasion, on the snap-action rocker can be prevented or reduced such that there is no effect on the snap-action closing function. As a result of this, the stopping point of the snap-action closing mechanism 8 can be prevented from being constantly displaced as a result of material abrasion, until the snap-action rocker 10 can no longer hold the extension 5 of the contact arm and the snap-action closing mechanism 8 becomes ineffective.

The present invention relates to an electrical switching device 1, it preferably being provided for the switching device 1 to be designed as a protective switching device or as an automatic circuit breaker. It is preferably provided for the switching device 1 to be designed as a line circuit breaker or a power switch, for example. The switching device 1 is preferably designed as a compact low-voltage protective switching device. In this case, the switching device 1 has at least one tripping device 33 according to the preferred embodiment. In each of FIG. 1 and FIG. 2, one electromagnetic tripping device 33 is shown, for example a short circuit tripping device. Moreover, a thermal tripping device designed in a known manner, for example a bi-metal tripping device for overcurrent tripping, can be provided. Furthermore, it can be provided for the tripping devices 33 in question to be combined.

The switching device 1 has at least one movable contact 4, and at least one contact 6 that is secured to the housing. According to the preferred embodiment shown, the switching device 1 has a so-called dual point breaker and consequently has two movable contacts 4 and two contacts 6 that are secured to the housing which are, however, assigned to a single switching path.

If the at least one movable contact 4 is connected in an electrically conductive manner to the at least one contact 6 that is secured to the housing, there is an electrically conductive current path through the switching device 1. The switching device 1 has terminals (not shown). If there is no such electrically conductive connection through or via the switching device 1, said device is described as being switched off or as being in the switched-off state. If the corresponding conductive connection does exist, said device is described as being switched on or as being in the switched-on state. The transitions between the two states are described accordingly and as is customary as switching on and switching off the switching device 1. The term closed contacts 4, 6 can be used synonymously for switched on and open contacts 4, 6 for switched off.

The at least one movable contact 4 is arranged on a movable contact arm 3. According to the preferred embodiment, the contact arm 3, which is shown separately in FIG. 10, has two movable contacts 4, which are each arranged on parallel fork-shaped extensions 34 of the contact arm 3, which can also be referred to in this embodiment as contact bridges or switch bridges.

At one end facing away from the at least one movable contact 4, the contact arm 3 has an extension 5 of the contact arm, which is designed in a hooked shape according to the preferred embodiment. In this case, according to the preferred embodiment, an end region 30 of the extension 5 of the contact arm is arranged substantially in parallel with a central piece 31 of the contact arm 3. In this case, varying angles can be provided according to the design conditions of the switching device 1 in question.

Furthermore, the contact arm 3 has a bearing 35, which is arranged between the at least one movable contact 4 and the extension 5 of the contact arm and is preferably constructed as an opening.

As a part through which current directly flows, the contact arm 3 is preferably designed comprising a copper-based alloy. According to the embodiment shown, the contact arm 3 is designed so as to be substantially formed in one piece, only the two movable contacts 4 being designed as a supporting surface made from an appropriate contact material. It can also be provided for the contact arm 3 to be formed of a plurality of parts and for only the regions of the contact arm 3 through which current directly flows to be designed comprising a highly conductive copper alloy, while the extension 5 of the contact arm is formed from another material. In practice, contact arms 3 formed in one piece especially have proven successful in terms of efficient production but also in terms of a rigid structure.

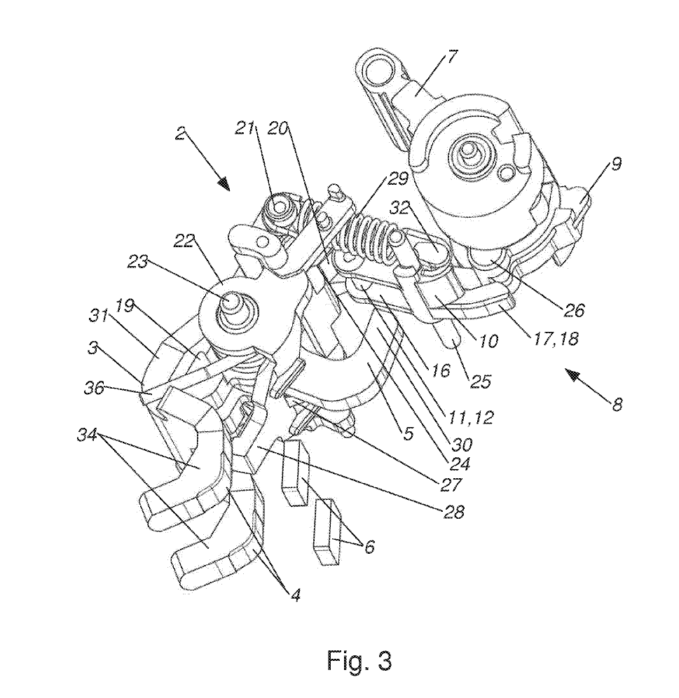

The switching device 1 has a breaker mechanism 2. The breaker mechanism is a mechanical arrangement, which controls the movements of the contact arm 3. In the preferred embodiment shown, the breaker mechanism 2 further has, in addition to the contact arm 3, a contact arm support 19, a latch 20 and a pawl 22. FIG. 3 is an axonometric view of the relevant assemblies separately from the other components of the switching device 1 in the switched-off state.

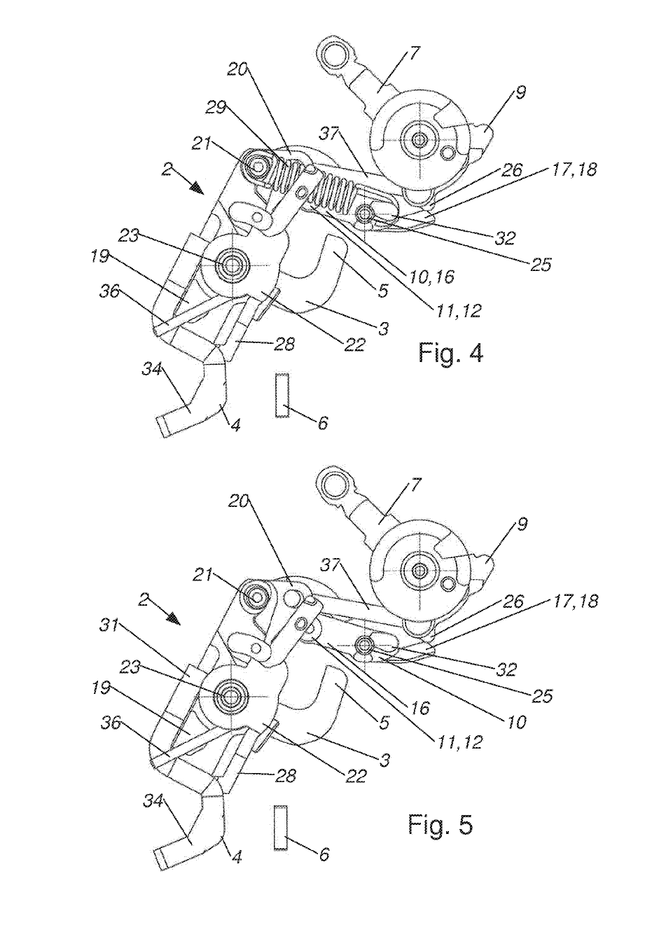

The contact arm support 19, the contact arm 3 and the pawl 22 are movably mounted in the breaker mechanism 2 about a common breaker mechanism axis of rotation 23 and each have corresponding openings or bearings. The three parts are each arranged so as to be movable relative to one another. According to the embodiment shown, two leg springs 36 are arranged between the contact arm support 19 and the contact arm 3 and bring about the contact pressure when the contacts 4, 6 are closed and press the contact arm 3 against the contact arm support 19 when the contacts 4, 6 are open, as is shown in FIG. 4 and FIG. 5. When the contacts 4, 6 are closed, the contact arm 3 is raised from the contact arm support 19 in regions, as shown for example in FIG. 7.

On the contact arm support 19, the latch 20 is movably mounted about a latch axis of rotation 21. The latch 20 is connected to the manually operated lever 7 of the switching device 1 by means of a bracket 37 or a rod.

The pawl 22 has a latching point 24 for connection to the latch 20. In the latched state, therefore when the latch 20 engages on the pawl 22, a movement, starting from a switched-off state of the switching device 1, of the manually operated lever 7 is transferred via the bracket 37 onto the latch 20. Since the latch 20 cannot move out of the way or swing out due to the latching, the contact arm support 19 and the contact arm 3 are also moved as a consequence of the movement of the manually operated lever 7.

Furthermore, the pawl 19 has a window 27, through which the extension 5 of the contact arm engages, and furthermore, has an extension 28 of the tripping device, which is arranged inside the switching device 1 opposite the tripping device tappet 38 of the tripping device 33, as shown for example in FIG. 1 and FIG. 2. By moving the pawl 19, that is by the tripping device tappet 38 hitting against the extension 28 of the tripping device, the latching between the latch 20 and the pawl 19 can be released, which leads to an opening of the contacts 4, 6.

Furthermore, the switching device has a snap-action closing mechanism 8. It has been described above how in the latched state a movement of the manually operated lever 7 leads to a movement of the contact arm 3 and consequently of the at least one contact. In order to prevent a constant and continuous approach in this process, the snap-action closing mechanism 8 is provided, which retains the contact arm 3 on the corresponding contact 6 that is secured to the housing during a specified approach of the at least one movable contact 4, while the movement of the manually operated lever 7 is continued. FIG. 4 and FIG. 5 each show the components in question in the switched-off state.

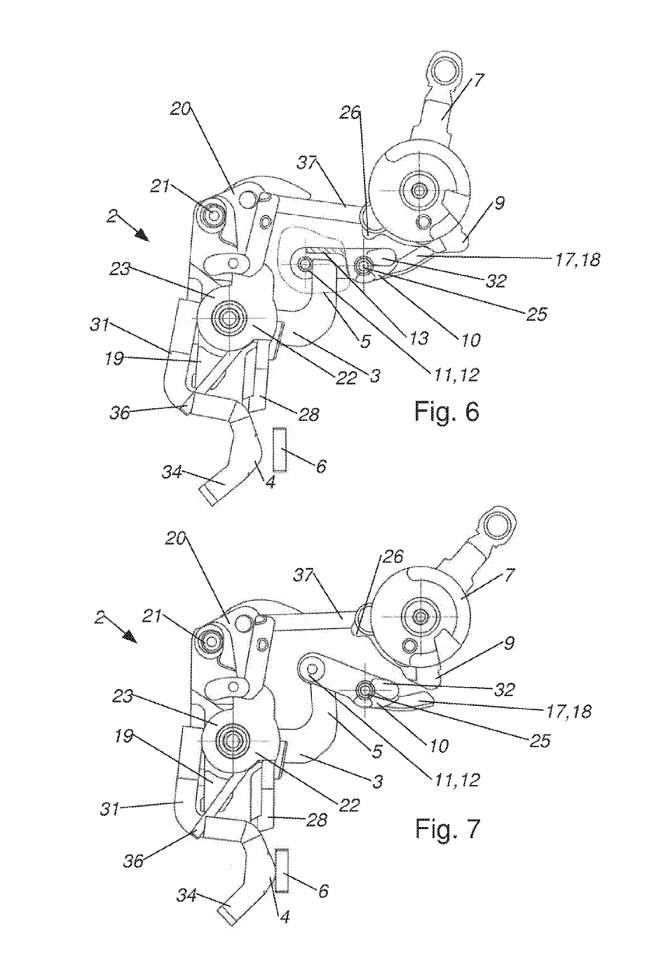

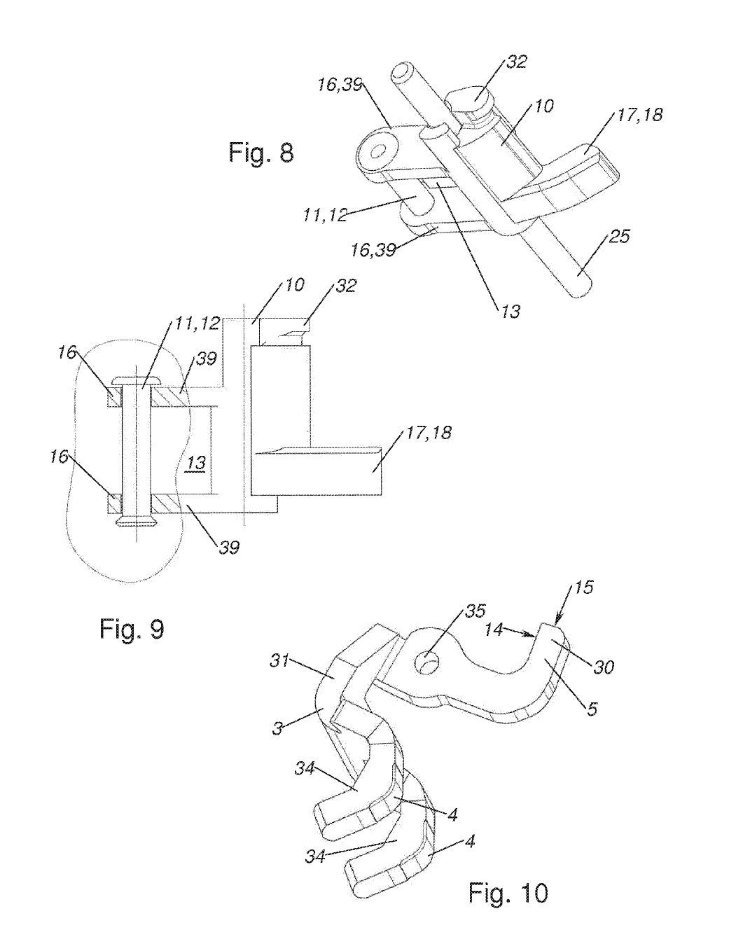

FIG. 6 shows a position in which the contact arm 3 is retained. In this case, the contacts 4, 6 are located at an isolation distance from one another which does not raise the expectation of any flashover. When a certain position of the manually operated lever 7 is transcended, a snap-action bridging of this isolation distance and a closing of the contacts 4, 6 occurs. As a result of this, the formation of an arc lasting long enough to lead to the destruction of the switching device 1 can be prevented. Due to the snap-action closing of the contacts 4, 6, it can also be ensured that the necessary contact pressure is available very quickly and is not just built up slowly, and no contact bounces occur.

The snap-action closing mechanism 8 has a snap-action rocker 10, which is rotatably mounted in the switching device 1 about a snap-action rocker axis of rotation 25. The snap-action rocker 10 has a contact arm-catching unit 11, which is provided and designed to come into contact with the extension 5 of the contact arm. In this case, it is provided for the contact arm-catching unit 11 to temporarily retain the extension 5 of the contact arm at the isolation distance and afterwards to release it in a predeterminable manner. For this purpose, the snap-action rocker 10 is controlled by a first cam 9 of the manually operated lever 7, the manually operated lever 7 furthermore having a second cam 26.

According to the preferred embodiment shown, the snap-action rocker 10 is designed as a lever, the contact arm-catching unit 11 being arranged on a first lever arm 16 of the snap-action rocker 10 and a second lever arm 17 of the snap-action rocker 10 being designed as an actuating extension 18 for coming into contact with at least the first cam 9 of the manually operated lever 7.

The snap-action rocker 10 is connected to the contact arm support 19 by means of a positioning spring 29. In this case, the positioning spring 29 in question, which is preferably designed as a screw tension spring, engages on the snap-action rocker 10 on a pin 32 which is arranged slightly eccentrically. In the switched-off position of the manually operated lever 7, the second cam 26 presses against the second lever arm 17 of the snap-action rocker 10 and presses the contact arm-catching unit 11 away from the extension 5 of the contact arm. The positioning spring 29 is substantially tension-free in this position. By moving the manually operated lever 7 towards the switched-on position, the second cam 26 is moved away from the second lever arm 17, as a result of which a pivoting of the snap-action rocker 10 is enabled. The positioning spring 29 is tensioned simultaneously since the contact arm support 19 is moved away. As a consequence of the force now being applied by the positioning spring 29, and the possibility of moving, the first lever arm 16 of the snap-action rocker 10 that supports the contact arm-catching unit 11 pivots towards the extension 5 of the contact arm that is likewise moving towards it, and they thereupon come to abut one another.

A continuation of the movement of the manually operated lever 7 now no longer leads to a movement of the contact arm 3 which is retained by the extension 5 of the contact arm at the contact arm-catching unit 11. FIG. 6 shows the corresponding position of the breaker mechanism 2 and the snap-action closing mechanism 8. If the manually operated lever 7 moves further towards switching on the switching device 1, a further movement of the contact arm support 19 occurs, as a result of which a further tensioning of the leg springs 36 occurs, and a regional “raising” of the contact arm 3 from the contact arm support 19. If the manually operated lever 7 is moved further accordingly, the first cam 9 comes into the region of the second lever arm 17 of the snap-action rocker 10. The first cam 9 subsequently presses the contact arm-catching unit 11 away from the extension 5 of the contact arm, as a result of which the contact arm 3 is released and a snap-action closing of the contacts 4, 6 occurs.

In this case, the contact arm 3 preferably abuts the contact arm-catching unit 11 by a first contact arm-retaining surface 14.

It is provided for the contact arm-catching unit 11 to have a surface hardness, which is greater than or equal to a surface hardness of the extension 5 of the contact arm, in particular the first contact arm-retaining surface 14. The surface hardness of the contact arm-catching unit 11 is therefore at least as great as the surface hardness of the extension 5 of the contact arm. In this case, the surface hardness or simply the hardness describes the resistance of the body in question and its surfaces to the penetration of a test body. Excessive wear of the contact arm-catching unit 11 can be avoided by the hardness of the contact arm-catching unit 11 compared to that of the extension 5 of the contact arm.

With regard to the surface hardness of the extension 5 of the contact arm, it is provided for the regions or parts of the extension 5 of the contact arm which are in contact with the contact arm-catching unit 11 or come into contact with it during operation to have the corresponding surface hardness compared to that of the contact arm-catching unit 11.

It is preferably provided for the hardness or surface hardness in question to be determined in accordance with the Vickers hardness test method.

In particular, it is provided for the contact arm-catching unit 11 to be designed comprising metal, it being provided in particular for the contact arm-catching unit 11 to be designed comprising steel.

It is preferably provided for the contact arm-catching unit 11 to be designed substantially so as to be rotationally symmetrical, as a result of which there is a good and low-friction sliding of the extension 5 of the contact arm from the contact arm-catching unit 11. In this case, it has proven to be advantageous for the contact arm-catching unit 11 to be designed as a round rivet and/or tubular rivet 12. According to the most preferred embodiment shown of a switching device 1, the contact arm-catching unit 11 is designed as a tubular rivet 12 made from steel. Furthermore, in addition to simple producibility and feasibility, such a rivet has high dimensional stability as a result of which a displacement of the isolation distance over many switching cycles can be prevented.

It is most preferable, and in particular when it is simple to design the contact arm-catching unit 11 as a round rivet and/or tubular rivet 12, if the contact arm-catching unit 11 is rotatably mounted in the snap-action rocker 10 about its own contact arm-catching unit axis. The extension 5 of the contact arm therefore rolls along the contact arm-catching unit 11, as a result of which the durability of the arrangement can be increased further.

It is preferably provided for the end region 30 of the extension 5 of the contact arm to be rounded in the region which is provided for abutment against the contact arm-catching unit 11 upon release thereof. As a result of this, the wear on the extension 5 of the contact arm and on the contact arm-catching unit 11 can be reduced further.

In the case of the preferred hook-shaped design of the extension 5 of the contact arm, it is preferably provided for the extension 5 of the contact arm to engage behind the contact arm-catching unit 11 when both parts are engaged. In this case, it is provided for the contact arm-catching unit 11 to be designed accordingly in order to allow such an engagement behind it. Accordingly, the contact arm-catching unit 11 preferably has a web-like superstructure, which connects two lateral legs 39 of the snap-action rocker 10. Such is provided in the case of the preferred rotationally symmetrical design of the contact arm-catching unit 11, as shown in the drawings. In this case, the extension 5 of the contact arm engages behind the contact arm-catching unit 11.

Furthermore, it is preferably provided for the snap-action rocker 10 to have a limiting stop 13 in the region of the contact arm-catching unit 11 and for the first contact arm-retaining surface 14 to abut the contact arm-catching unit 11 and a second contact arm-retaining surface 15 to abut the limiting stop 13 when the extension 5 of the contact arm engages with the snap-action rocker 10. In this case, the second contact arm-retaining surface 15 is preferably arranged substantially normal to the first contact arm-retaining surface 14. The limiting stop 13 prevents the extension 5 of the contact arm from penetrating too far or too deep into the snap-action rocker 10. As a result of this, the intended function of the snap-action closing device can be ensured further.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A switching device, comprising:
a fixed contact secured to a housing and a movable contact, the movable contact being arranged on a contact arm which is configured to be movable inside the switching device, the contact arm including an extension of the contact arm facing away from the movable contact, the movable contact being configured to contact the fixed contact and to establish a conductive current path through the switching device;
a breaker mechanism connected to the movable contact arm;
a manually operated lever connected to the breaker mechanism; and
a snap-action closing mechanism including a snap-action rocker mounted so as to be rotatably movable, controlled by a first cam of the manually operated lever, the snap-action rocker including a contact arm-catching unit configured to contact the extension of the contact arm,
wherein the contact arm-catching unit has a surface hardness which is greater than or equal to a surface hardness of the extension of the contact arm.

2. The device of claim 1, wherein the contact arm-catching unit includes metal.

3. The device of claim 1, wherein the contact arm-catching unit includes steel.

4. The device of claim 1, wherein the extension of the contact arm is hook-shaped.

5. The device of claim 1, wherein the extension of the contact arm engages behind the contact arm-catching unit.

6. The device of claim 1, wherein the contact arm-catching unit is rotationally symmetrical.

7. The device of claim 6, wherein the contact arm-catching unit is a round rivet.

8. The device of claim 6, wherein the contact arm-catching unit is rotatably mounted in the snap-action rocker.

9. The device of claim 1, wherein the snap-action rocker includes a limiting stop in a region of the contact arm-catching unit and
wherein a first contact arm-retaining surface abuts the contact arm-catching unit and a second contact arm-retaining surface abuts the limiting stop when the extension of the contact arm engages with the snap-action rocker.

10. The device of claim 9, wherein the first contact arm-retaining surface is arranged substantially normal to the second contact arm-retaining surface.

11. The device of claim 1, wherein the snap-action rocker is a lever that is mounted so as to be rotatably movable,
wherein the contact arm-catching unit is arranged on a first lever arm of the snap-action rocker, and
a second lever arm of the snap-action rocker is an actuating extension configured to contact the first cam of the manually operated lever.

12. The device of claim 6, wherein the contact arm-catching unit is a tubular rivet.

13. The switching device of claim 1, wherein the switching device is a protective switching device.
